(19) United States
(12) Patent Application Publication
(10) Pub. No.: US 2008/0316674 A1
(43) Pub. Date: Dec. 25, 2008

(54) Capacitors and methods for fabricating the same

(75) Inventors: Hsiao-Che Wu, Taoyuan Hsien (TW); Ming-Yen Li, Kaohsiung County (TW); Wen-Li Tsai, Kaohsiung County (TW)

Correspondence Address: BIRCH STEWART KOLASCH & BIRCH, PO BOX 747, FALLS CHURCH, VA, 22040-0747, US

(73) Assignee: ProMOS Technologies Inc.

(21) Appl. No.: 12/000,145

(22) Filed: Dec. 10, 2007

(30) Foreign Application Priority Data
Jun. 23, 2007 (TW) 96122697

(51) Int. Cl. H01G 4/06; H01G 9/00

(52) U.S. Cl. 361/311; 29/25.03

(57) ABSTRACT

Capacitors and methods for fabricating the same are provided. An exemplary embodiment of a capacitor comprises a dielectric layer and a first conductive layer thereover. A supporting rib is embedded in the first conductive layer and extends along a first direction. A second conductive layer is embedded in the first conductive layer and extends along a second direction perpendicular with the first direction, wherein a portion of the second conductive layer forms across the supporting rib and is structurally supported by the supporting rib. A capacitor layer is formed between the first and second conductive layers to electrically insulate the first and second conductive layers.

### BACKGROUND

The invention relates to semiconductor memory devices, and in particular relates to a capacitor for a semiconductor memory device and a method for fabricating the same.

Dynamic random access memory (DRAM) device is a kind of a volatile memory device. Digital data storage in a DRAM device is executed by charge and discharge of the capacitor in the DRAM device. When power supplied to the DRAM device is turned off, the data stored in the memory cell of the DRAM device completely disappears. A memory cell in the DRAM device typically includes at least one field effect transistor (FET) and one capacitor. The capacitor is used for storing signals in the cells of the DRAM device.

Recently, with DRAM device memory cells shrinking, maintaining appropriate charge capacitance of the capacitor has fallen behind memory cell shrinking technology. A conventional way to maintain charge capacitance capacity level for a size-reduced memory device is to increase a surface area in the capacitor by growing hemispherical grain (HSG), for example, silicon materials, thereby increasing surface areas in a predetermined space in the capacitor for disposing a capacitor layer and maintaining charge capacitance of the capacitor after formation of a sequential multi-layered capacitor structure over the HSG.

Nevertheless, manufacturing of the HSG typically requires high process temperatures and a longer processing time. Size of the HSG formed in a space such a trench is also limited. Therefore, integration of the HSG within a DRAM device using trenches as a place for forming the capacitor has become problematic.

### SUMMARY

Capacitors and methods for fabricating the same are provided to thereby solve the above issues for conventional DRAM memory devices.

An exemplary embodiment of a capacitor comprises a dielectric layer and a first conductive layer thereover. A supporting rib is embedded in the first conductive layer and extends along a first direction. A second conductive layer is embedded in the first conductive layer and extends along a second direction perpendicular with the first direction, wherein a portion of the second conductive layer forms across the supporting rib and is structurally supported by the supporting rib. A capacitor layer is formed between the first and second conductive layers to electrically insulate the first and second conductive layers.

An exemplary embodiment of a method for fabricating a capacitor comprises providing a first dielectric layer. A second dielectric layer is formed over the first dielectric layer. A first trench is formed in the second dielectric layer and extends along a first direction. A support layer is formed to fill up the first trench. A third dielectric layer is formed over the second dielectric layer, wherein the third dielectric layer covers the support layer. A second trench of substantially W-shaped appearance is formed in the second and third dielectric layers, wherein a portion of the second trench forms across the support layer along a second direction perpendicular to the first direction to expose portions of a bottom surface of the second dielectric layer, sidewalls of the second and third dielectric layers, and a top surface of the support layer. A second conductive layer is conformably formed in the second trench to cover the bottom surface of the second dielectric layer, the sidewalls of the second and third dielectric layers, and the top surface of the support layer is exposed by the second trench, wherein the second conductive layer is substantially W-shaped. An etching process is performed to remove the third and second dielectric layers and leaves the second conductive layer and exposes a portion of the first dielectric layer, wherein a portion of the second conductive layer is structurally supported by the support layer. A capacitor layer is formed over the second conductive layer and first dielectric layer. A first conductive layer is blanketly formed over the capacitor layer, the second conductive layer and the first dielectric layer, and the second conductive layer, the support layer and the capacitor layer are embedded in the first conductive layer.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIGS. 1, 3, 6, 9, 12, 15, 18, and 21 are schematic diagrams showing top views at various fabrication steps of a method for fabricating a capacitor according to an exemplary embodiment of the invention; and

FIG. 2 is a schematic diagram showing a cross section along line 2-2 in FIG. 1;

FIG. 4 is a schematic diagram showing a cross section along line 4-4 in FIG. 3;

FIG. 5 is a schematic diagram showing a cross section along line 5-5 in FIG. 3;

FIG. 7 is a schematic diagram showing a cross section along line 7-7 in FIG. 6;

FIG. 8 is a schematic diagram showing a cross section along line 8-8 in FIG. 6;

FIG. 10 is a schematic diagram showing a cross section along line 10-10 in FIG. 9;

FIG. 11 is a schematic diagram showing a cross section along line 11-11 in FIG. 9;

FIG. 13 is a schematic diagram showing a cross section along line 13-13 in FIG. 12;

FIG. 14 is a schematic diagram showing a cross section along line 14-14 in FIG. 12;

FIG. 16 is a schematic diagram showing a cross section along line 16-16 in FIG. 15;

FIG. 17 is a schematic diagram showing a cross section along line 17-17 in FIG. 15;

FIG. 19 is a schematic diagram showing a cross section along line 19-19 in FIG. 18;

FIG. 20 is a schematic diagram showing a cross section along line 20-20 in FIG. 18;

FIG. 22 is a schematic diagram showing a cross section along line 22-22 in FIG. 21;

FIG. 23 is a schematic diagram showing a cross section along line 23-23 in FIG. 21; and

FIG. 24 is a schematic stereo-diagram showing a capacitor according to an exemplary embodiment of the invention.

### DETAILED DESCRIPTION

The following description is of the best-contemplated mode of carrying out the invention. This description is made for the purpose of illustrating the general principles of the invention and should not be taken in a limiting sense. The scope of the invention is best determined by reference to the appended claims.

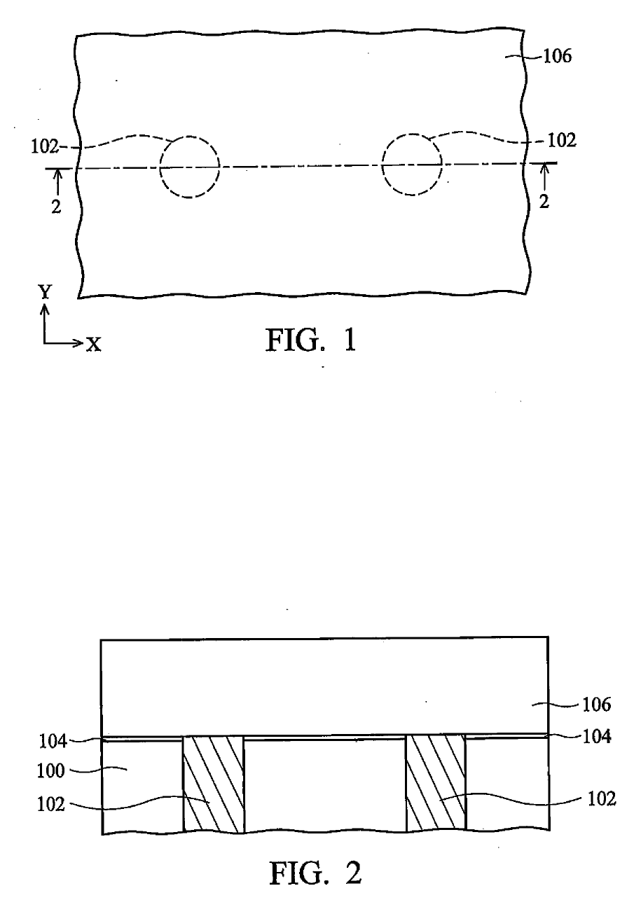

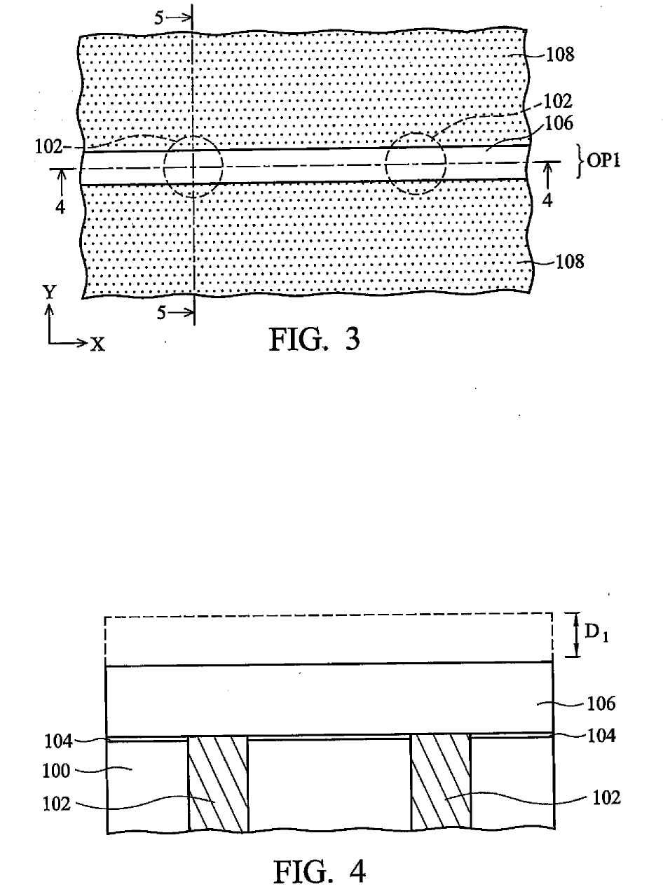

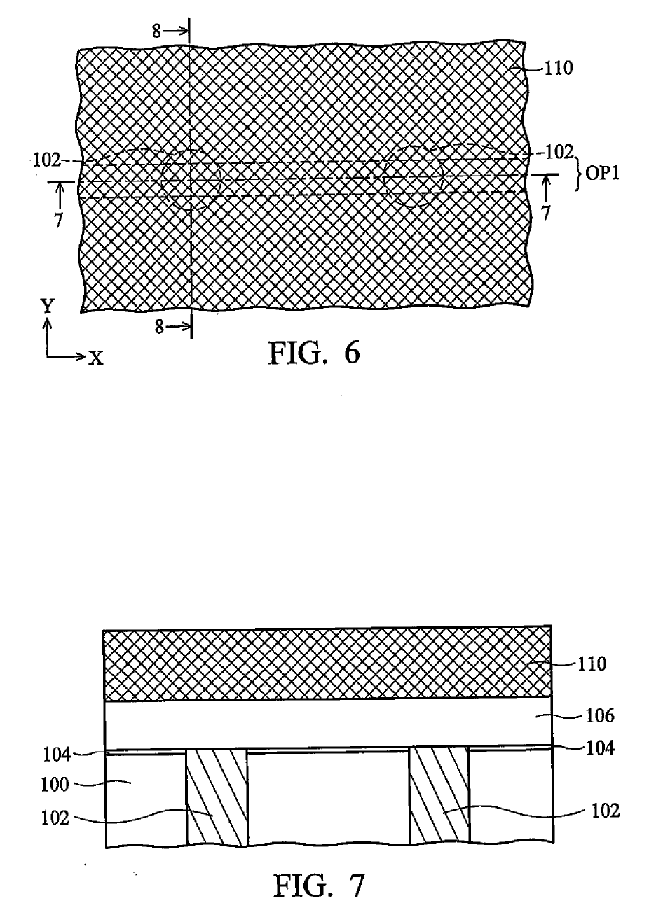

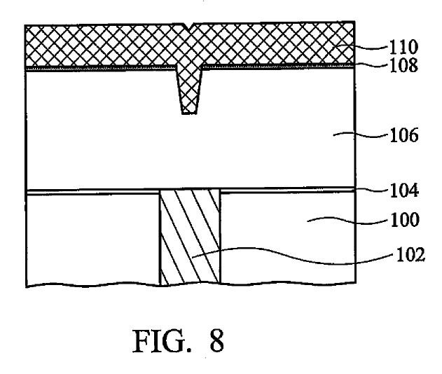

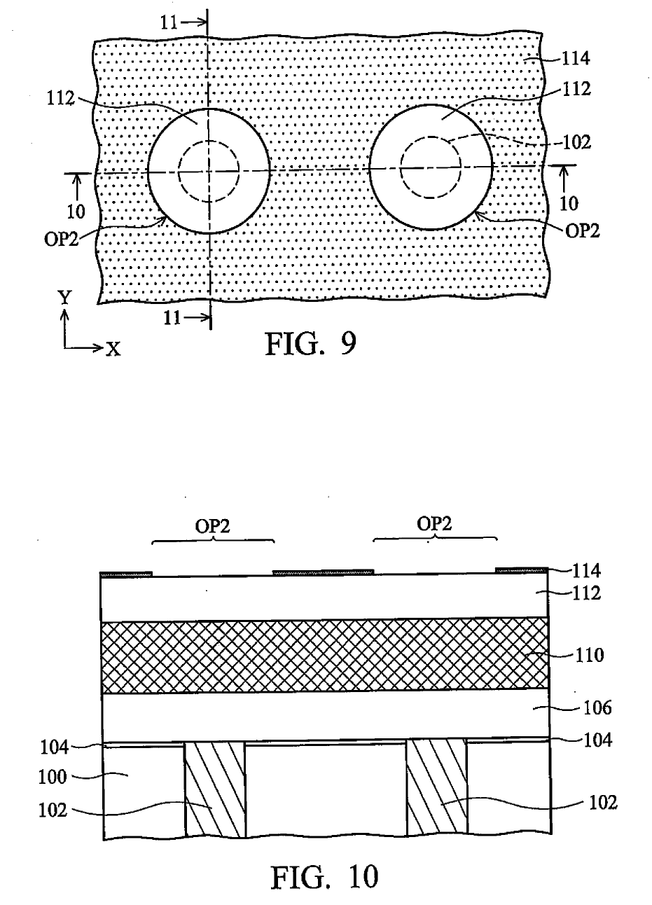

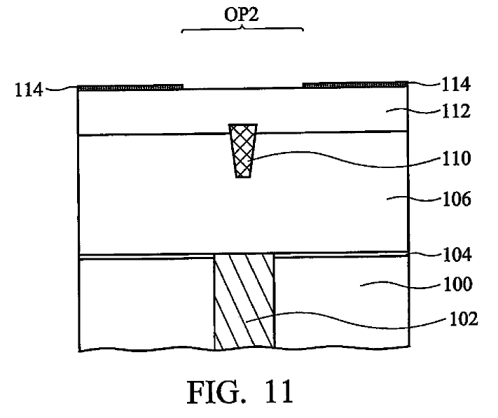

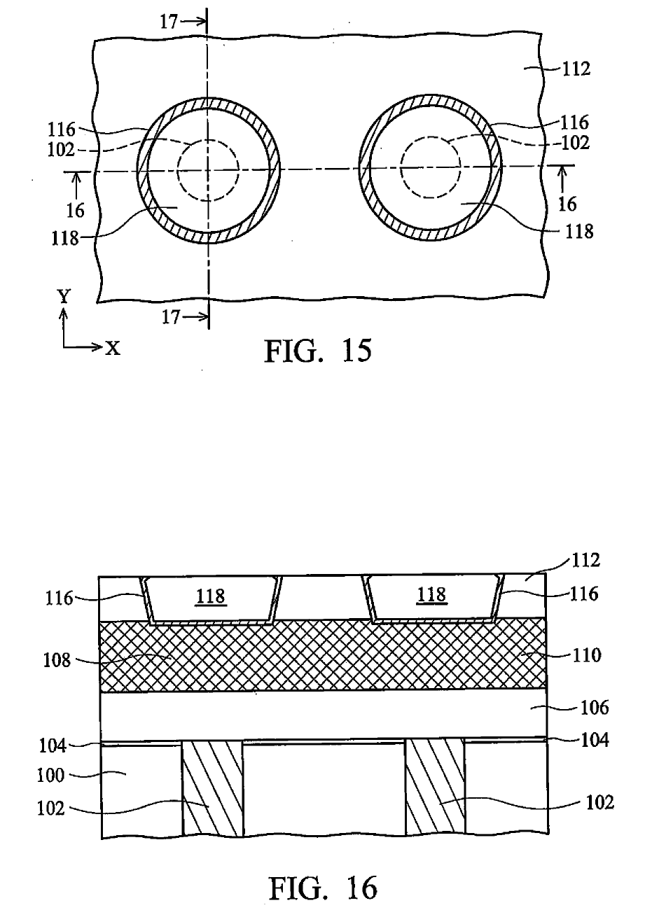

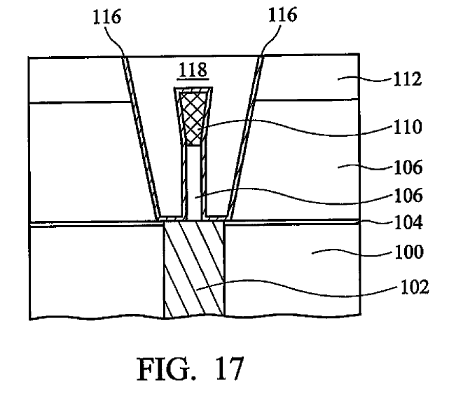

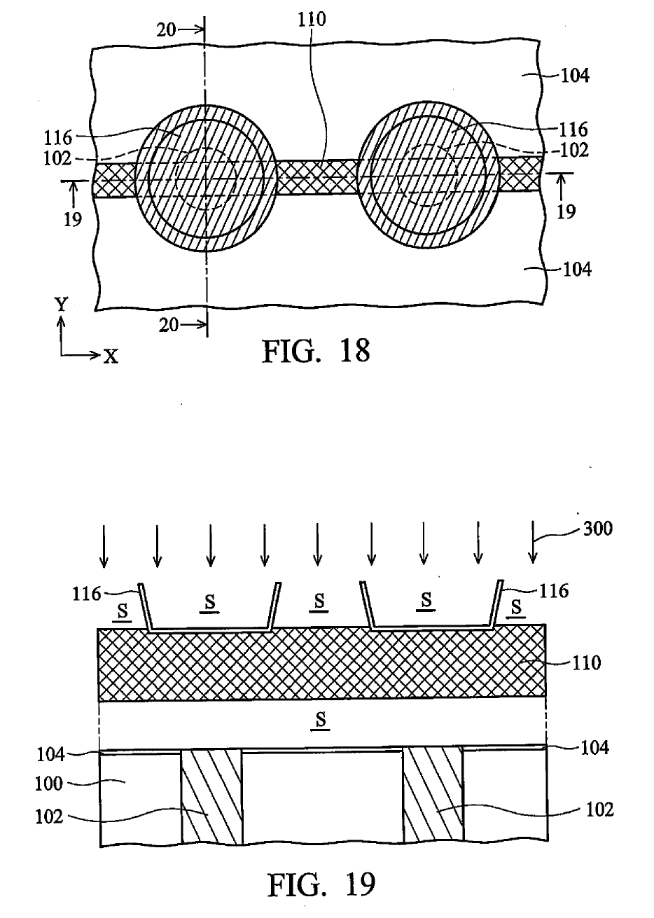

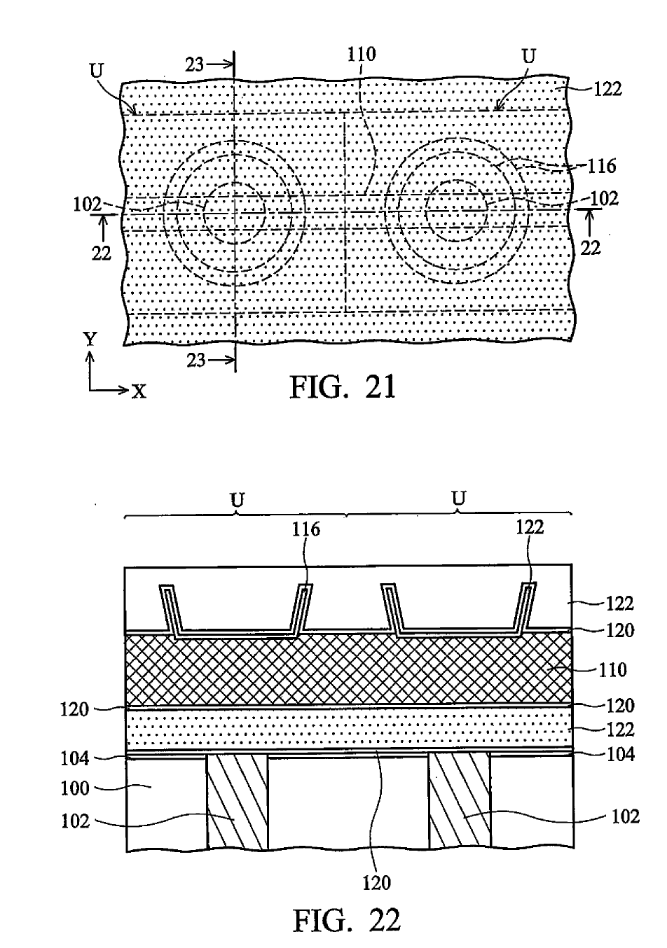

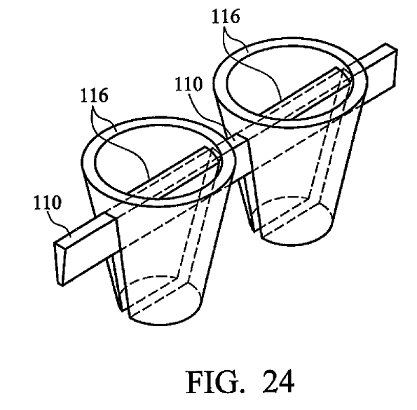

Exemplary embodiments of capacitors and methods for fabricating the same are described as below incorporating FIGS. 1-24, wherein FIGS. 1, 3, 6, 9, 12, 15, 18, and 21 are schematic diagrams showing top views at various fabrication steps of a method for fabricating a capacitor according to an exemplary embodiment. FIGS. 2, 4, 5, 7, 8, 10, 11, 13, 14, 16, 17, 19, 20, 22, and 23 are schematic diagrams showing cross sections taken along line 2-2 of FIG. 1, line 4-4 of FIG. 3, line 5-5 of FIG. 3, line 7-7 of FIG. 6, line 8-8 of FIG. 6, line 10-10 of FIG. 9, line 11-11 of FIG. 9, line 13-13 of FIG. 12, line 14-14 of FIG. 12, line 16-16 of FIG. 15, line 17-17 of FIG. 15, line 19-19 of FIG. 18, line 20-20 of FIG. 18, line 22-22 of FIG. 21, and line 23-23 of FIG. 21, respectively. FIG. 24 is a schematic stereo-diagram showing a capacitor structure according to another exemplary embodiment.

In FIGS. 1 and 2, a semiconductor structure is first provided. The semiconductor structure is located at a semiconductor memory cell region (not shown), such as a dynamic random access memory (DRAM) device memory cell region. Herein, the semiconductor structure includes a first dielectric layer 100 and an etching stop layer 104 with a pair of the conductive contacts 102 formed therein. The semiconductor structure illustrated in FIGS. 1 and 2 further includes a semiconductor substrate (not shown) and a plurality of field effect transistors (FETs, not shown) formed thereon. The conductive contacts 102 respectively electrically connect the FETs formed over the semiconductor substrate. For simplicity, the semiconductor substrate is merely illustrated as the first dielectric layer 100, the etching stop layer 104 formed over the first dielectric layer 100, and the conductive contacts 102 penetrating the above layers without illustrating the underlying semiconductor substrate and the FETs. Herein, the first dielectric layer 100 may comprise insulating materials such as undoped silicon glass (USG), phosphorus silicon glass (PSG), boron phosphorus silicon glass (BPSG) or silicon dioxide. The etching stop layer 104 may comprise materials such as silicon nitride or silicon oxynitride. The conductive contacts 102 may include conductive materials such as tungsten (W), doped polysilicon or metal silicide.

In FIGS. 3, 4, and 5, a second dielectric layer 106 and a mask layer 108 are blanketly formed over the structure illustrated in FIGS. 1 and 2 to cover the etching stop layer 104 and the conductive contacts 102. The mask layer 108 may be a silicon nitride layer and the second dielectric layer 106 may comprise insulating materials such as undoped silicon glass (USG), phosphorus silicon glass (PSG), boron phosphorus silicon glass (BPSG) or silicon dioxide. A photolithography process and an etching process (both not shown) are next performed to pattern the mask layer 108 and partially remove portions of the second dielectric layer 106 not covered by the mask layer 108, thereby forming a trench OP1 through portions of the mask layer 108 and the second dielectric layer 106. The trench OP1 is illustrated as a trench extending substantially along an X direction in FIG. 3 and substantially disposed over a place above the conductive contacts 102, having a dimension less than the critical dimension of the conductive contacts 102.

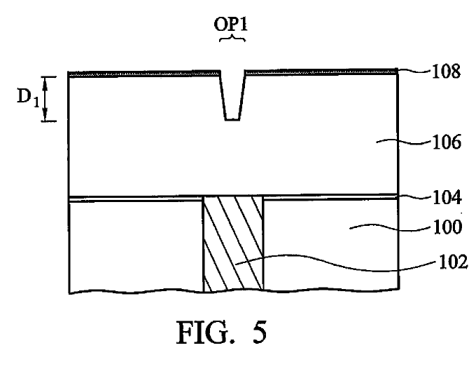

FIG. 4 illustrates a cross section taken along line 4-4 of FIG. 3, showing a cross section in the trench OP1. Herein, the mask layer 108 in the trench OP1 is patterned and partially removed and the second dielectric layer 106 therein is also partially removed, thereby having a reduced thickness. FIG. 5 illustrates a cross section taken along line 5-5 of FIG. 3, showing a cross section across the trench OP1 and the second dielectric layer 106 adjacent thereto along a Y direction in FIG. 3. Herein, the trench OP1 is illustrated with a tapered configuration but is not restricted thereto. The surface of the second dielectric layer 106 exposed by the trench OP1 in FIG. 4 has a depth D1 to the top surface of the mask layer 108 adjacent thereto. The trench OP1 preferably has an aspect ratio more than 3.

In FIGS. 6, 7, and 8, a support layer 110 is blanketly formed over the structure illustrated in FIGS. 3, 4 and 5 and fills the trench OP1. The support layer 110 may comprise silicon nitride and may be formed by, for example, chemical vapor deposition. Herein, since the second dielectric layer 106 in the trench OP1 has a thickness difference therebetween the region adjacent to trench OP1, the support layer 110 formed in the trench OP1 and formed over the mask layer 108 adjacent to the trench OP1 thus also has a thickness difference therebetween.

In FIGS. 9, 10 and 11, an etching process (not shown) is performed to the support layer 110 in the structure illustrated in FIGS. 6, 7 and 8, thereby removing the portion of the support layer 110 above the mask layer 108. The mask layer 108 is next removed to leave the support layer 110 merely in the trench OP1 and exposes the surface of the second dielectric layer 106 adjacent to the trench OP1. Next, a third dielectric layer 112 and a mask layer 114 are blanketly formed over the support layer 110 and the third dielectric layer 112 in sequence, thereby covering the support layer 110 and the second dielectric layer 106 and simultaneously leveling the trench OP1 and the surface of the structure adjacent thereto. Herein, the mask layer 114 may be a silicon nitride layer and the third dielectric layer 112 may comprise insulating materials such as undoped silicon glass (USG), phosphorus silicon glass (PSG), boron phosphorus silicon glass (BPSG) or silicon dioxide. Next, a photolithography process and an etching process (both not shown) are sequentially performed to pattern the mask layer 114, thereby forming a plurality of opening OP2 therein. As shown in FIG. 9, the openings OP2 substantially superimpose over the top of the conductive contacts 102, respectively, and have substantial circular or oval top view and a larger critical dimension (i.e. diameter). The openings OP2 substantially define a place for forming the capacitors of the semiconductor memory device cell structure.

In FIGS. 12, 13 and 14, an etching process 200 is performed to the structure illustrated in FIGS. 9, 10 and 11 using the mask layer 114 as an etching mask, thereby forming trench T1 in the portion the third dielectric layer 112 and the second dielectric layer 106 exposed by the opening OP2. The etching process 200 is a composite etching process including a dry etching step and a wet etching step. The dry etching step is first substantially performed to remove the portions of the third dielectric layer 112 and the second dielectric layer 106 which equals to the opening OP2 and the wet etching process is then performed to remove portions of the sidewalls of the third dielectric layer 112 and second dielectric layer 106 adjacent to the opening OP2 and simultaneously remove the second dielectric layer 106 underlying the support layer 110 which is masked by thereto. Thus, the trench T1 is formed with a practical region larger than the region exposed by the openings OP2 illustrated in FIG. 12.

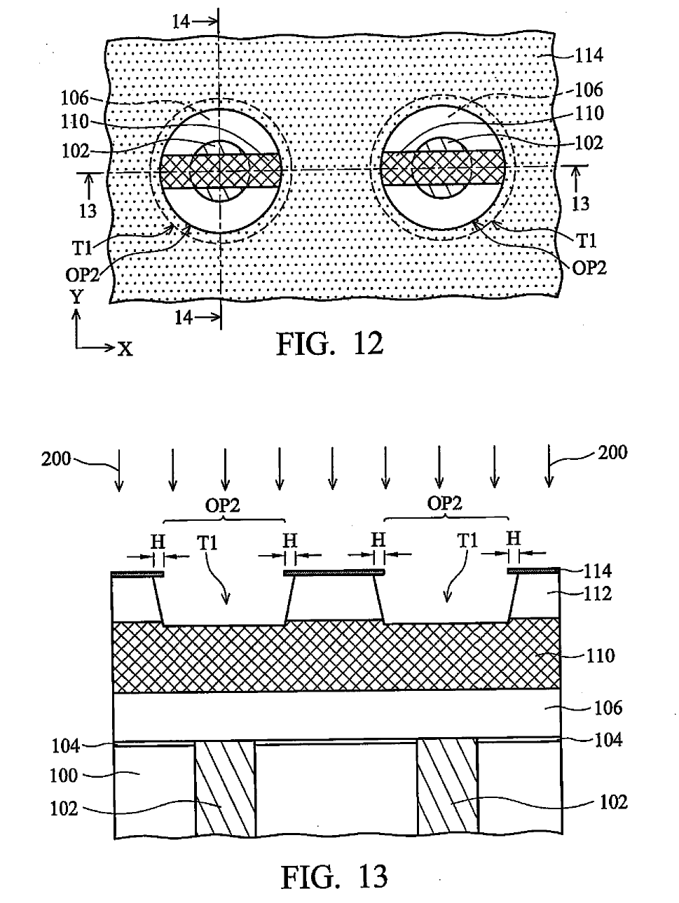

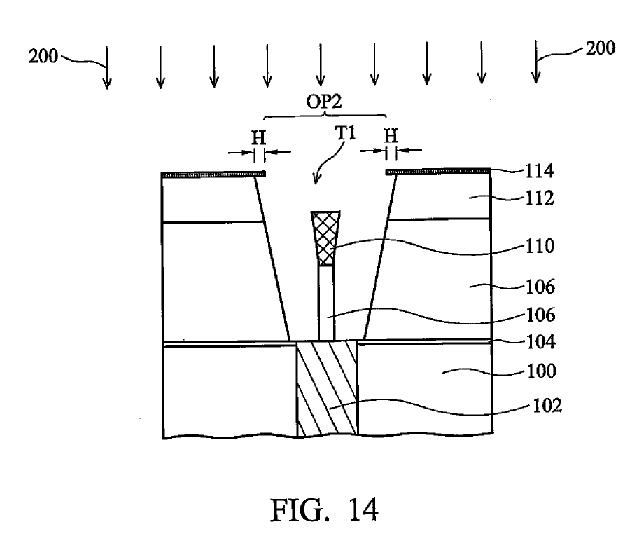

As shown in FIGS. 13 and 14, the trench T1 illustrated in FIG. 12 has different aspect ratios on X and Y directions thereof. In FIG. 13, the trench T1 is formed merely in portions of the third dielectric layer 112 and exposes the support layer 110. As shown in FIG. 14, the trench T1 penetrates downward portions of the third dielectric layer 112 and the second dielectric layer 106, and exposes portions of the etching stop layer 104 and the conductive contacts 102 thereunder, thereby having a substantially W-shaped cross section and a larger aspect ratio. As shown in FIG. 14, the trench T1 also exposes a top surface of the support layer 110 therein and the support layer 110 is substantially located at a center of the trench T1.

In FIGS. 15, 16 and 17, a second conductive layer 116 is conformably formed over the structure illustrated in FIGS. 12, 13 and 14. The second conductive layer 116 is then conformably formed over the mask layer 114 and the third dielectric layer 112 and the second dielectric layer 106 which were exposed by the trench T1 and the support layer 110. A fourth dielectric layer 118 is then blanketly formed over the second conductive layer 116 and covers the second conductive layer 116, thereby filling up the trench T1. Next, a chemical mechanical polishing (CMP) process or a dry etching process is performed to remove the portion of the fourth dielectric layer 118 and the second conductive layer 116 over the mask layer 114, thereby after removing the mask layer 114 and obtain the structure illustrated in FIGS. 15, 16 and 17. Herein, the third dielectric layer 112, the second dielectric layer 106 and the support layer 110 in the trench T1 are formed with a second conductive layer 116 thereon, and the upper region of second conductive layer 116 is formed with a fourth dielectric layer 118 thereover. The second conductive layer 116 and the fourth dielectric layer 118 are now coplanar with the third dielectric layer 112. The second conductive layer 116 may comprise conductive materials such as tungsten (W), titanium (Ti), titanium nitride (TiN), tantalum (Ta), tantalum nitride (TaN), platinum (Pt), ruthenium (Ru) or doped polysilicon. The fourth dielectric layer 118 may comprise insulating materials such as spin-on glass (SOG), undoped silicon glass (USG), phosphorus silicon glass (PSG), boron phosphorus silicon glass (BPSG) or silicon dioxide.

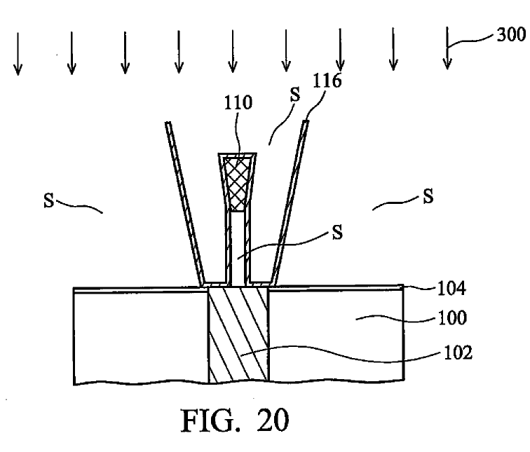

In FIGS. 18, 19 and 20, an etching process 300, for example a wet etching process, is then performed to remove the third dielectric layer 112 and the second dielectric layer 106 illustrated in FIGS. 15, 16 and 17, thereby exposing the etching stop layer 104 and the conductive contacts 102 and forming a plurality of spaces S near the second conductive layer 116. Herein, the third dielectric layer 112 and the second dielectric layer 106 comprise same types of dielectric materials to benefit progresses of the etching process 300. As shown in FIG. 18, and in FIGS. 19 and 20, after the etching process 300, the second conductive layer 116 forms across the support layer 110 and is structurally supported by thereof, thereby being not collapse after removal of the third dielectric layer 112 and the second dielectric layer 106, having a substantially W-shaped cross section. As shown in FIG. 18, the second conductive layer 116 has a substantially circular top view. FIG. 24 shows a three dimensional stereo-diagram showing structures illustrated in FIGS. 18, 19 and 20. As shown in FIG. 24, the second conductive layer 116 is formed with a hallow circular cup configuration and the support layer 110 is formed as a rib configuration penetrating and embedding in the second conductive layer 116 to thereby structurally support thereof.

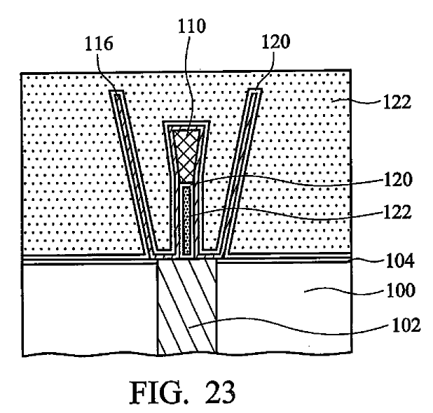

In FIGS. 21, 22 and 23, a capacitor layer 120 is then conformably formed over the structure illustrated in FIGS. 18, 19 and 20. The capacitor layer 120 conformably covers the exposed surface of the support layer 110 and the second conductive layer 116 and can be formed by, for example, atomic layer deposition (ALD). Next, a first conductive layer 122 is blanketly formed to cover the capacitor layer 120 and leaves a substantially planar surface. Herein, the capacitor layer 120 may comprise nitrogen-containing materials such as silicon nitride or silicon oxynitride or high-k dielectric material such as Al₂O₃, ZrO₂, BST, STO, Ta₂O₅, or HfO₂. The first conductive layer 122 may comprise conductive materials such as W, Ti, TiN, Ta, TaN, Pt, Ru or doped polysilicon and can be formed by atomic layer deposition (ALD) or chemical vapor deposition (CVD). The capacitor layer 120 is formed over all the exposed surface of the second conductive layer 116 and at least on the exposed surfaces of the second conductive layer 116 (e.g. the portion of the surface of the second conductive layer 116 over the support layer 110, the conductive contacts 102 and the etching stop layer 104 as illustrated in FIGS. 19 and 20). The capacitor layer 120 can also be formed on opposing surfaces of portions of the second conductive layer 116 (e.g. the protrusion portions of the second conductive layer 116 as illustrated in FIGS. 19 and 20), thereby increasing charge storage capacity of a formed capacitor. In addition, as shown in FIGS. 22 and 23, the capacitor layer 120 and the first conductive layer 122 can also be formed at a place under the support layer 110, thereby providing additional charge storage capacity.

Fabrication of a capacitor is substantially illustrated through the above schematic diagrams. As shown in FIGS. 21, 22, and 23, an area U can be substantially viewed as a region for forming a charge storage capacitor of a memory cell of the semiconductor memory device. Herein, a capacitor in the region U substantially includes a dielectric layer (e.g. the first dielectric layer 100) and a first conductive layer thereover (e.g. the first conductive layer 122). A supporting rib (e.g. the support layer 110) is embedded in the first conductive layer and extends along a first direction (e.g. the X direction in FIG. 21). A second conductive layer (e.g. the second conductive layer 116) is embedded in the first conductive layer and extends along a second direction (e.g. the Y direction in FIG. 21) perpendicular with the first direction, wherein a portion of the second conductive layer is formed across the supporting rib and is structurally supported by the supporting rib. A capacitor layer (e.g. the capacitor layer 120) is formed between the first and second conductive layers to electrically insulate the first and second conductive layers.

Due to formation of the support layer 110, the bottom electrode (i.e. the second conductive layer 116) of the capacitor is structurally supported during fabrication thereof without doubts of collapse thereto and a substantially hollow cylinder configuration is thus obtained (see FIGS. 18, 19 and 20). In portions of the bottom electrode, the capacitor layer 120 is merely disposed over a single surface thereof (e.g. the second conductive layer 116 contacts with the underlying layers in the bottom portions) and most portions of the bottom electrode are disposed over two opposing surface of the bottom electrode (e.g. the second conductive layer 116 do not contact with the protrusion portions of the underlying layers), thereby providing more surfaces for forming the capacitor layer. Thus, charge storage capacity of the capacitor can be thus increased as desired when the size of the transistor incorporated therewithin is further reduced, thereby providing a predetermined charge storage capacity. Moreover, the method of fabricating the capacitor in the above exemplary embodiments also avoid an undesired high temperature processing step conducted using the conventional HSG techniques and thus can be easily integrated with present manufacturing processes without affecting reliability of the semiconductor memory device.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A capacitor, comprising:
a dielectric layer;
a first conductive layer over the dielectric layer;
a supporting rib embedded in the first conductive layer and extended along a first direction;
a second conductive layer embedded in the first conductive layer and extended along a second direction perpendicular with the first direction, wherein a portion of the second conductive layer forms across the supporting rib and is structurally supported by the supporting rib; and
a capacitor layer formed between the first and second conductive layers and electrically insulated the first and second conductive layers.

2. The capacitor as claimed in claim 1, wherein the second conductive layer has a substantially W-shaped cross section.

3. The capacitor as claimed in claim 2, wherein the second conductive layer has a plurality of bottom portions and a plurality of protrusion portions, the bottom portions are separated from each other and respectively contacts the dielectric layer, and the protrusion portions do not contact the dielectric layer.

4. The capacitor as claimed in claim 1, wherein the capacitor layer is disposed over the bottom portions of the first conductive layer to electrically insulate the first and second conductive layers.

5. The capacitor as claimed in claim 3, wherein the capacitor layer is disposed on two opposing surfaces of the protrusion portions of the second conductive layer to electrically insulating the first and second conductive layers.

6. The capacitor as claimed in claim 1, wherein the capacitor layer comprises nitrogen-containing dielectric materials or high-k dielectric materials.

7. The capacitor as claimed in claim 1, wherein the first and second conductive layers comprise W, Ti, TiN, Ta, TaN, Pt, Ru or doped polysilicon.

8. A method for fabricating a capacitor, comprising:
providing a first dielectric layer; forming a second dielectric layer over the first dielectric layer;
forming a first trench in the second dielectric layer, wherein the first trench extends along a first direction;
forming a support layer in the first trench and filling the first trench;
forming a third dielectric layer is formed over the second dielectric layer, wherein the third dielectric layer covers the support layer;
forming a second trench has a substantially W-shaped appearance in the second and third dielectric layers, wherein a portion of the second trench forms across the support layer along a second direction which is perpendicular to the first direction, therefore, exposing portions of a bottom surface of the second dielectric layer, sidewalls of the second and third dielectric layers, and a top surface of the support layer;
conformably forming a second conductive layer in the second trench, covering the bottom surface of the second dielectric layer, the sidewalls of the second and third dielectric layers, and the top surface of the support layer exposed by the second trench, wherein the first conductive layer is substantially W-shaped;
performing an etching process, removing the third and second dielectric layers, leaving the second conductive layer and exposing a portion of the first dielectric layer, wherein a portion of the second conductive layer is structurally supported by the support layer;
forming a capacitor layer is formed over the surface of the second conductive layer and first dielectric layer;
blanketly forming a first conductive layer over the capacitor layer, the second conductive layer and the first dielectric layer; and
embedding the second conductive layer, the support layer and the capacitor layer in the first conductive layer.

9. The method as claimed in claim 8, wherein the second conductive layer has a plurality of bottom portions and a plurality of protrusion portions, the bottom portions are separated from each other and respectively contact the first dielectric layer, and the protrusion portions do not contact with the first dielectric layer.

10. The method as claimed in claim 9, wherein the capacitor layer is disposed over the bottom portions of the first conductive layer to electrically insulate the first and second conductive layers.

11. The method as claimed in claim 9, wherein the capacitor layer is disposed on two opposing surfaces of the protrusion portions of the second conductive layer to electrically insulate the first and second conductive layers.

12. The method as claimed in claim 8, wherein the capacitor layer comprises nitrogen-containing dielectric materials or high-k dielectric materials.

13. The method as claimed in claim 8, wherein the first and second conductive layers comprise W, Ti, TiN, Ta, TaN, Pt, Ru or doped polysilicon.

14. The method as claimed in claim 8, wherein the second and third dielectric layer comprises same type of dielectric materials.

15. The method as claimed in claim 8, wherein the etching process includes a wet etching process.

16. The method as claimed in claim 8, wherein the second trench has a substantially circular or oval top surface.
